(19) United States
(12) Patent Application Publication
(10) Pub. No.: US 2003/0040850 A1
(43) Pub. Date: Feb. 27, 2003

(54) Intelligent adaptive optimization of display navigation and data sharing

(76) Inventors: Amir Najmi, Menlo Park, CA (US); Ali Siddiqui, Fremont, CA (US)

Correspondence Address: ELLIOT B. ARONSON, 5001 HARBORD DRIVE, OAKLAND, CA, 94618

(21) Appl. No.: 10/038,494

(22) Filed: Jan. 3, 2002

Related U.S. Application Data
(63) Continuation-in-part of application No. 09/923,916, filed on Aug. 7, 2001.

(51) Int. Cl. G05D 1/00

(52) U.S. Cl. 701/1

(57) ABSTRACT

A method and apparatus for optimizing the navigation of lists or other hierarchies of alternatives, as presented to the user by electronic devices and computer networks, by automatically recommending the alternatives of the next list to be presented. Each alternative is recommended on the basis of the importance of that alternative to the user, or to the operator of the service provided to the user, or to providers of applications that can be selected by the user. The optimization is based upon probabilities estimated by mathematical functions on several variables, statistics, and parameters, including but not limited to the user location, time and date, user's expressed personal preferences, service operators' and application providers' expressed commercial intentions, service operators' and application providers' expressed business rules, implied application relationships, personal information of the user, usage statistics of the user, usage statistics of the general public, and embedded parameters which refine a statistical model of the user's behavior, statistics and estimators based upon that model, and a business objective model of the revenue improvements of service operators using this invention. Such optimization reduces the efforts required of a user to select one item, out of a structure of lists of items, by reorganizing the structure so that the user is likely to use fewer keystrokes or spoken words to select an item of combined higher importance to the user, the service operator, and the application provider. The optimization is personalized to each user by presenting the lists and structures to each user in a way that is automatically adapted to the statistical and deterministic factors pertaining to that individual user, so that users of different personalities and preferences can see or hear differently organized lists from which to choose. The number of keystrokes, or spoken words, is further reduced by intelligent data sharing between applications to avoid requiring the user's reentry of the same data to one application that was already entered in another.

### BACKGROUND OF THE INVENTION

The present invention relates to the intelligent sharing of data between, and navigation of, lists or other arrangements of alternative choices such as may be presented to a user on electronic devices such as a computer display monitor, a cellular telephone display, a PDA display, a wired telephone, or even specialized instrument panel displays. The invention is more particularly directed to optimization techniques for enabling the user to navigate through large numbers of choices to get to the selections that are relevant to the user, or to a provider of service to the user, more quickly and with less effort. The invention is more particularly directed, as well, to the intelligent sharing of data so as to reduce the user's effort in entering the data.

With advances in computer technology, wireless and wired networks, Internet connectivity, and database development, vast amounts of information have become readily available to users throughout the world, who are now also able to engage in various electronic actions such as sending and receiving messages over telephone or other messaging systems, sending and receiving faxes, and undertaking banking transactions, to mention just a few examples. Indeed, many business and individual users have become dependent on the availability of such information and the ability to engage in such actions.

As the demand for more and more computer-accessible information has increased, so has the development of search methodologies and data organization schemes that reduce the burden on the user to sort through this profusion of alternatives. Along with this the variety of business, consumer or other activities that may be undertaken electronically has also increased. In addition to the messaging, faxing and banking transactions referred to above, it is now common for example to make purchases on-line, to contact customer service centers, to trade in stock markets throughout the world on-line, or to engage in a number of less critical but more frequent tasks such as checking a basket ball score or finding a movie on-line. Accompanying the proliferation in information available and in transactions that may be undertaken electronically is the development of further devices capable of accessing information or engaging in electronic transactions—for example, personal digital assistants (PDAs), web-enabled cellular telephones, web-enabled automated teller machines (ATMs), and specialized electronic kiosks in retail outlets. Some of these devices have only limited display capability and the user is presented with lists of choices to scroll through. The limited display capability of many devices produces a bottleneck in reaching the desired information or action item.

A specific example from the world of Internet access by wireless telephone will illustrate the nature of this problem and will also illustrate the utility of the invention for internet-enabled wireless telephones, although as will become apparent below the invention has utility to a wide variety of other devices and computer networks. Cell phones typically include a small LCD screen for displaying the telephone number dialed as well as various messages and commands. For a cell phone that is equipped to access the Internet all information must be presented on the small screen. This is commonly done by presenting the user with lists of choices on the screen. At present, the wireless telephone market favors cell phones that are as tiny as possible without rendering the screens unreadable and the keyboards unusable. The tradeoff for minuteness is the inconvenience and discomfort experienced by the user in scrolling down long lists of alternatives that do not all fit on the tiny screen and in composing lengthy keystroke sequences on the tiny keypad or keyboard to navigate the Internet. This inconvenience and discomfort discourages many potential users from venturing onto the Internet over cell phones with the resultant effect of impeding the commercial development of the wireless Internet.

As a direct result of the market demand for cell phone miniaturization, a cell phone screen may be limited to as few as only four items showing at any one time. In other systems such as synthesized-voice answering systems using the spoken word to list alternatives, the problem can be more severe because of the time required to carefully articulate each word in a long list. To select the desired item from a list displayed on a cell phone, the user must click on a key repeatedly to advance a pointer to the desired item. If the desired item is not one of the four visible at any time, the user must click on a scrolling button which in some cell phones displays the next four items. Should the user desire to select the last item in a list of twenty alternatives, for instance, then four screen scroll clicks plus three advancing clicks plus a selection click, for a total of eight clicks, are required to select the item. Should that selection itself be a further list of items, the process must be repeated until the desired end destination is selected. So, for example, with only three levels of lists, the final selection might take as many as twenty-four clicks, by which time many users will have impatiently abandoned the chore. The experience for the user is very much more agreeable if the final choice is among the first four at the first or second level.

The sequence of a user's actions in advancing through a structure of alternatives presented electronically is commonly referred to as “navigation.” The general problem illustrated by the above cell phone example is the difficulty, inconvenience or tedium for a user to navigate through a complex of choices to find the target choice that provides the information the user seeks or that initiates the action the user desires to initiate. The problem is most severe with users of small electronic devices such as cell phones, PDAs, automated menus over manual touch-tone telephones, certain input devices to computer networks, automobile internal function selectors, or any of a number of other devices where items of the lists are spoken, or the display space is severely limited or typing is inconvenient. Although the problem is exacerbated in such limited electronic devices, the problem is nevertheless present in other settings as well, such as computer monitors having a much larger screen area for displaying information and full keyboards for data entry. Here the screen may provide the user with many choices at once in the form of screen buttons, icons, links or other hot spots, but more often than not the displayed choices contain many irrelevant ones, and the user is still called upon to navigate through a hierarchy of clicks to reach the target information or action.

A number of schemes have been devised to present information or action choices in a more meaningful way to more users. In some schemes the information or activities themselves are organized in categorical groupings believed to be meaningful, which are then arranged in hierarchical ways that are believed to provide access more quickly. Others call for collecting data on the individual user or having the user pre-select categories of potentially interesting information or activities and then using such information to customize the presentation to the user. Other schemes propose gathering statistics on prior usage and tailoring the presentation based at least in part on the frequency of the user's past choices. While all of these approaches may have their respective advantages or benefits, they have not proven themselves sufficiently robust to eliminate the access bottleneck of limited-display devices as in internet-enabled cell phones and even in computers with comparatively large display screens have been only partially successful in reducing the level of difficulty or inconvenience in locating specific items within the totality of choices.

### SUMMARY OF THE INVENTION

The present invention provides a method and apparatus for presenting alternative choices to a user that greatly enhances the likelihood that the earliest choices presented will be highly relevant to the user or to a provider of service to the user. The methodology of the invention is particularly suited for use with electronic devices such as cell phones that have a limited display capability, such devices typically only being able to display at most a relatively small, characteristic number of items to the user at a time, although the invention may also be used to advantage in connection with larger displays such as full-screen computer monitors. Although “display” is usually understood to mean visual display, it is used herein in a broader sense to include also aural and spoken communication of alternatives such as over a manual telephone or with voice-activation devices. Similarly, when reference is made herein to a user “selecting” or “making a selection,” in that context the terms “selecting” and “selection” are understood broadly to mean any manner of expressing a selection, including for example keystrokes, mouse clicks, touchscreen entries, as well as voice-activated commands. The entity responsible for giving users access to a multitude of end alternatives from which to make a selection is referred to herein generally as the service provider. In the cell phone example, the service provider is the entity providing cell phone users with access to the Internet. The end alternatives themselves will generally constitute or be provided by software applications and are often referred to herein simply as “applications.” “Application provider” refers to the entity that is the source of an application. The application provider will generally be a third party, although in particular instances it could also be the service operator or even the end user.

It is an object of the invention to reduce the effort and inconvenience of navigation that a user faces in having to go through multiple layers of choices to find the sought-after end alternative. It is a significant advantage of the invention that it appreciably reduces the access bottleneck inherent in devices with limited display capability. This is accomplished by reorganizing the structure of alternatives with the goal that the fewer the keystrokes, clicks or spoken words required to select any particular end alternative, the less likely the user is to be discouraged from selecting it. The invention accomplishes this objective by providing a user behavior model of the user's behavior in making choices and an objective model for taking into account the objectives of others operatively combined with the user behavior model for adjusting the actions and effects of the user behavior model. The objective model is a business-objective model in the cell phone example above, although other objective may be embodied in the model for non-business contexts. These models are applied to transform an input structure having a first organization of alternative choices into a recommended structure having an organization of alternative choices in which the choices nearest the top of the structure will be relevant to the user's quest with a high probability. More generally, the invention provides a mathematical and algorithmic formulation for balancing such factors as individual and collective user behavior, business objectives of service operators, of application providers and of others, and other influences for use in transforming the input structure of alternatives into the recommended structure. The formulations of the invention are able to take into account such factors as the user's express preferences, the user's personal data such as age, gender, residence locality and occupation, and usage frequencies by the user, by the public in general, or by a similarly situated segment of the public. It is an advantage of the present invention that the business objective model is also able to take into account various other types of objectives or utilitarian factors such as the desires of the service operator or third-party advertisers to influence which end alternatives the user is likely to search out.

Briefly, an objective model is applied to a first ordered selection of alternative choices to compute a probability for each selectable alternative according to the intended user's probability to select the alternative as modified by the commercial intentions expressed by the service operator, application provider, or other third parties. The intended probabilities are calculated by optimizing a certain function of the objective model referred to as the Objective Function. The optimization procedure takes into account the order of importance of each intermediate or end alternative or application to the user, to the service operator, and to the application provider or others. The optimization procedure derives a recommended selection of choices of optimized order, which recommended choices are then presented to the user in their optimized order. For example, on an electronic device capable of displaying only four items at a time, the recommended selection of choices derived from the business objective model is displayed four or five at a time, in the case of a conventional cell phone screen, in the optimized order to maximize the likelihood that the alternatives most important to the user are presented first.

In one embodiment the recommendations are inferred by an optimization engine that statistically learns the tastes and choices of each individual user automatically without the necessity of conscious effort by the user. The optimization engine then estimates the probabilities that the individual user might select each application and adjusts those probabilities to account for the commercial intentions and biases that may be explicitly expressed by the service operator and by the application provider as well as by other third-party providers such as advertisers. The estimating functions may use the statistics of the user's past selections, the user's explicitly stated preferences, the user's location, the time and date, the advertiser's expressed preferences, personal data known about the user, the usage statistics of the general public or of a similarly situated segment of the public, and the embedded parameters which refine a statistical model of the user's behavior. The invention optimizes the overall number of keystrokes or clicks required of the user in relationship to the probabilities of each alternative that the user will select it. Recommendations are made according to the overall optimization. In the cell phone example described above, the first four recommendations, at each step in the selection process, appear as the visible list displayed by the cell phone, thereby reducing the user's burden of time, effort, and inconvenience when accessing the Internet over the cell phone.

By way of example, the first list of alternatives might consist of the 31 items shown on some particular day on the home page of a popular web portal, which range from “Autos” to “Yellow Pages.” That ordering of lists may be acceptable on the full screen for which it was intended, but a similar ordering on a cell phone would require 31 clicks to select the 31^{st} entry, including the scrolling click after the fourth entry of each screen. By contrast, the optimized list of some particular businessperson, waiting in an airport, might first recommend the four items that are the most probable candidates for that businessperson to select at that time at that airport. They might be, for example, “Flights,” “Stock Quotes,” “Sports,” and “SMS” (Short Message Service, the cell phone equivalent to email). As another example, the four recommendations for a young lady on a midday shopping tour, might be “SMS,” “Beauty & Fashions,” “Restaurants,” and “Stock Quotes.” In either example, the item just selected might itself be a list. For instance, if a businessperson from San Francisco had selected “Sports” on a Sunday afternoon in football season, his or her next recommended list might be “Raiders Schedule,” “49er Schedule,” “Listen to Game,” “NFL.” Five clicks are needed to access the 49er schedule. Had the portal structure been used without optimization, the businessperson would have needed 26 clicks.

Several prior art personalized navigation systems are based upon explicit user inputs to the system in order to specify user preferences. In one form of prior art, initiated by Amazon.com, users of the web site are invited to explicitly choose the kind of advertisement or application they prefer to invoke, conditioned upon the advertisement or application they are viewing at the moment. In another form of prior art, popular in web portals such as AOL, Yahoo, and Excite, users are invited to select which alternatives they prefer to see on the home screen of the portal. In still another form of prior art, found for example in Microsoft Word, users are invited to express their preferences by clicking on dozens of items in lists of options provided by the application. For example, a user may prefer blue background with white text to white background with black text. Common to this prior art is the need for the user to explicitly state fixed preferences in order to personalize the application or portal. The personalization can be changed by the user at any time, but between such explicit changes by the user the personalized presentation is fixed and remains constant. Such personalized navigation schemes have no inherent software or hardware intelligence to automatically adapt to new or changing circumstances.

Unlike these prior art schemes, the statistical formulations of the invention are particularly advantageous because fixed user preferences that are originated or modified only by the user, or some other person, cannot accurately personalize an electronic device or computer network for each individual user. The information to be personalized can change quickly and without notice, for example the frequent and unending introduction of new web sites on Internet. In addition to changes in the user's electronic environment, each user's personal tastes can change quickly and without notice. For example a sudden change in the stock market might motivate some users to review their stock portfolios more often during a period of flux, then less often during a period of stability. Any automatically adapting personalization of navigational alternatives must be based upon usage statistics of some form in order to accurately estimate the items of interest during periods of introduction or change. Statistical analysis is required because no single sample of a user's choices can be expected to accurately predict the user's next choice. The statistical formulations of the invention provide for accurate, up-to-date personalization, and the Empirical Bayes statistical formulations are uniquely accurate in their predictions. Although the recommendations of the optimization engine of the invention are based upon uniquely accurate statistics, they are further influenced by the other factors, such as location or date as mentioned above. Such other factors serve several purposes. First, they more accurately define the personal context of the user, and therefore the more appropriate statistics. Second, they introduce new possibilities that may not have a high probability of choice simply because the user is unaware of them. Third, they allow the operator of the wireless service to suggest alternatives which may be equally acceptable to the user, but preferred by the operator of the service.

In another of its aspects the invention provides for controlling the variability of the displayed optimization recommendations. Briefly, if the change in optimization does not exceed a prescribed threshold, then the recommended tree to be presented to the user does not change. The threshold level is referred to as an adaptivity parameter which in essence controls the sensitivity of the optimization procedure. The parameter may be set by the service operator or in some embodiments by the end user. Setting a low adaptivity level will avoid minor variations in the recommended tree that do not provide any significant improvement in the recommendations to the user but that the user may find annoying. A higher setting of this parameter may be desirable to some users, who may find that the recommended tree changes too frequently for comfort.

In another form of adaptivity the user or service operator may choose to have only a limited portion of the user's display devoted to the recommended tree. For example, a user may desire to have only three lines of a four-line display show entries from the recommended tree while the fourth line is used for another purpose. A second adaptivity parameter controls this setting.

In another aspect of the invention a Boost Level parameter may be set to temporarily promote or diminish an individual application or category of applications so that it will appear higher or lower in the recommended tree than it otherwise would have. The boost level may be adjusted for example by the service operator for temporary commercial promotions or for other purposes.

The invention further provides for reducing the user's effort after the user has selected a desired alternative by providing a prefill feature, by which a request for data from the selected application is prefilled with information already available within the system. For example, the application software invoked by a user's selection may request information that the user has not yet provided to that application, but which may have been invoked by a previous, unrelated application or may otherwise reside in the user's system. For example, a user of a cell phone desiring to order a taxicab might contact the service operator portal and be directed to a taxicab company's software application for ordering a cab. The taxicab application then asks for the address of the pickup. The address can be uncomfortably lengthy for a user to enter, especially on a limited device such as a cell phone. However, it sometimes happens that the user has already provided the requested information to some other application that was previously invoked by the user. For example, the user might have already made reservations at a restaurant and, before leaving the restaurant, then called a taxicab to arrange a pickup at the restaurant. It may be that a previously invoked application shares no data with the requesting application and that the restaurant has no arrangements for sharing data with the taxicab company. In such cases, the invention can match the type of data object requested by the requesting application with data objects previously recorded or passed through the device to other applications. According to the invention, likely matches can be displayed in such a way that the user can select one of the alternatives displayed. The complete data represented by the selected data object can then be provided to the requesting application as if entered directly by the user. In the taxicab example the restaurant may provide its address to the service operator for example when registering with the service operator to be included in the service operator portal. The taxicab application, in requesting an address, triggers an action to display likely address objects for the user to choose from. The restaurant is a likely address in this situation and therefore appears as a possible alternative. The cell phone user selects the restaurant address, which then prefills the taxicab application request for the pickup address data. The information used by this prefill aspect of the invention can be obtained from several different sources by several different methods. For example, prefill information can be obtained not only from the information provided by the user to other applications, or from information registered with the service operator, but also from specific information provided by a service operator or an application provider for the purpose of prefill, or by platform services such as “location services” and “time-of-day.” Location services provide data items based upon the current physical location of a mobile device and may include, for example, the street address or the latitude and longitude. The time-of-day data may include actual time of day, as well as day of week. This prefill capability can lead to a significant reduction in the user's effort by replacing what can amount to tens of keystrokes to enter an entire address with a single keystroke to select the desired address not merely from those in the user's electronic address book, but more expansively from those previously invoked by unrelated applications or other sources.

In another of its aspects the invention provides a control panel and an Application Programming Interface (API) to assist in the development of services and applications incorporating the advantages of the invention. The API enables the service operator and the application provider to define the variables and parameters which influence the user's selection of any item and to define any forms that may be desired for the user to fill in to use a particular service or application.

Thus, it is an overall advantage of the invention that it does not merely weight alternatives according to pre-set probabilities, either fixed or conditional, or according to pre-set incidence matrices incorporating pre-established rules, but rather the resulting order in any recommended tree or other data structure is dynamic, readily changing and changeable in response to a large number of pre-determined or real-time influences as readily updated by optimizing the Objective Function. In accord with the invention an estimator is provided for estimating a mean value of the user's frequency or probability in making a particular choice. The use of an Empirical Bayes estimator is particularly beneficial in taking into account a wide variety of objective and subjective criteria in determining the recommended organizational structure for the alternatives choices.

Other aspects, advantages, and novel features of the invention are described below or will be readily apparent to those skilled in the art from the following specifications and drawings of illustrative embodiments.

### BRIEF DESCRIPTION OF THE DRAWINGS

FIG. 1 is a high-level block diagram of an illustrative system according to the invention for use with an internet-enabled cellular telephone system.

FIG. 2 is a tree diagram showing a portion of a generic tree.

FIG. 3 is an expanded view of a cell phone display screen showing a list of alternatives.

FIG. 4 is a tree diagram showing a portion of a recommended tree.

FIG. 5 is a tree diagram showing a correlation list.

FIG. 6 is a diagram showing an initializing correlation matrix.

FIG. 7 is a data flow diagram showing the major object classes for an implementation of the invention.

### DETAILED DESCRIPTION OF ILLUSTRATIVE EMBODIMENTS

For purposes of illustration an embodiment of the invention is described in connection with an internet-enabled cellular telephone system. This embodiment is offered only by way of example and no limitation only to cellular telephone systems or to systems operating over the Internet is thus intended. By way of terminology the entity that provides for access to the Internet over the telephones is referred to herein as the service operator, or for short simply the operator. In commercial reality the service operator may consist of two or more companies cooperating to make Internet service available to cell phone users, and such are referred to here collectively as the operator. In other environments the operator will generally be the entity or cooperating entities that are responsible for giving users of the system access to a multitude of applications from which to choose, which access may be provided over the internet or over other networks or systems depending upon the particular environment at issue. The subscribers to the service are generally referred to here as users. The end alternatives or “final destinations” offered to users by the service operator will generally constitute or be provided by software applications and are referred to herein as end alternatives or sometimes simply as “applications.” “Application provider” refers to the entity that is the source of an application. The application provider will generally be a third party, although in particular instances it could also be the service operator or even the end user, who might provide his or her own specialized application. As with the service operator, in commercial reality an application provider may consist of two or more companies cooperating to make an application available, and such are referred to here collectively as the application provider.

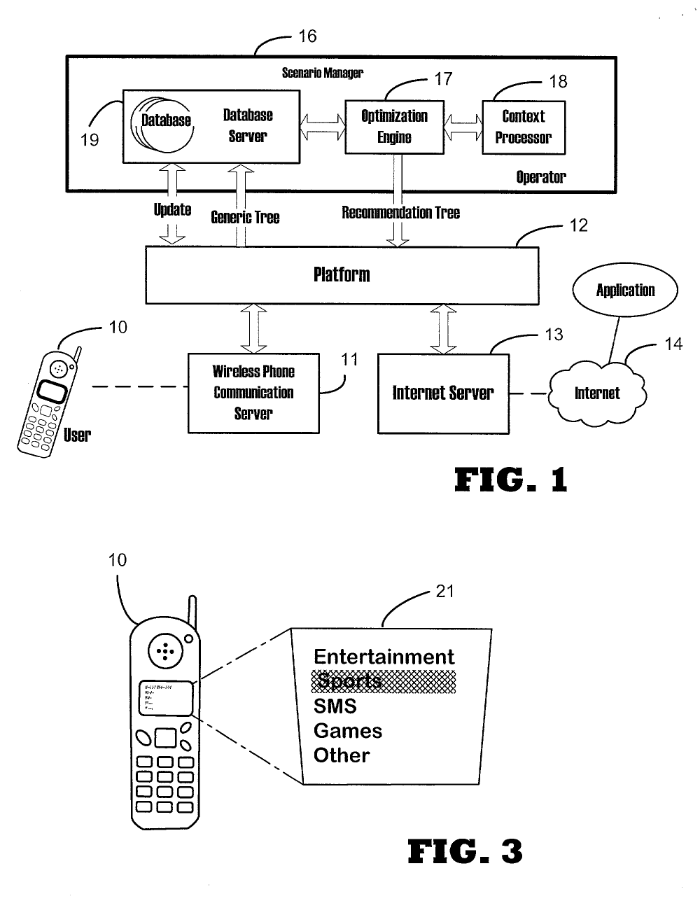

FIG. 1 shows an overview of the illustrative system. The user enters the system through cell phone 10. Keystrokes, sometimes called “clicks,” are conducted by the cell phone network through a communication server 11 of the service operator to server-side middleware, generally referred to here as the platform 12 and generally hosted by the operator. The platform communicates with Internet server 13 for establishing connection to the Internet indicated generally at reference numeral 14.

The intelligent navigation optimization and intelligent data sharing of the present invention are governed here by a scenario manager 16, which in turn comprises an optimization engine 17, context processor 18, and database server 19. Optimization engine 17 implements the statistical modeling and calculational algorithms used to enable intelligent navigation through the plurality of alternative applications available to a user. Context processor 18 provides an electronic-intelligence engine that interprets context information for the optimization engine. For example, if a user has directly declared or implicitly shown a preference for Italian restaurants, and that user subsequently searches for restaurants on the Internet, the optimization engine and the context processor cooperate to make Italian restaurants appear with greater ranking. Database server 19 governs the flow of information for the optimization engine and context processor.

In the embodiment of FIG. 1 all information used by the scenario manager is obtained from platform 12, cached in database server 19, processed, and returned to platform 12. This arrangement is offered here for purposes of illustration; other caching schemes and/or other data transfer arrangements or telecommunications schemes may also be used to implement the invention. Platform 12 is responsible for passing the processed information through communication server 11 to cell phone 10 or through Internet server 13 to the application provider at its web site, ftp site, email mailbox or other internet contact address. The application provider likewise responds to the platform middleware, and thus to the scenario manager, through the Internet and Internet server. A connected sequence of events that take place between the user on cell phone 10 and the application server on the Internet is referred to here as a scenario. All data that remains constant during a scenario is updated to and from database server 19 and platform 12 in an “off-line” mode. The update mode is referred to as off-line because the user whose data is being updated need not be on-line during the update. In practice the off-line mode may in fact be a background mode for those users with continuous Internet connections.

### Transformations of Trees

Optimization engine 17 operates on a set of alternative choices available to a user and provides a recommended ordering of the choices that represents an optimal balancing of the preferences, statistics, or other characteristics pertaining to a user as well as any commercial preferences and biases of the service operators, application providers or other third parties. At the outset, optimization engine 17 starts with an initial, generic ordering of alternatives lacking in any substantial personalization to a given user. It transforms this initial ordering into a recommended ordering optimized for the user. In subsequent sessions the optimization engine may revise the recommended ordering to take into account changes in the likely scenarios pertinent to the user. For example, the optimization engine may be configured to take into account such changes as user location, time of day, day of the week, recently selected applications, or overall changes in any rules, statistics or correlations pertinent to the user, to mention only a few factors. Based on the new information the engine then provides a re-ordering of the user's choices that will be more pertinent to the user's likely needs.

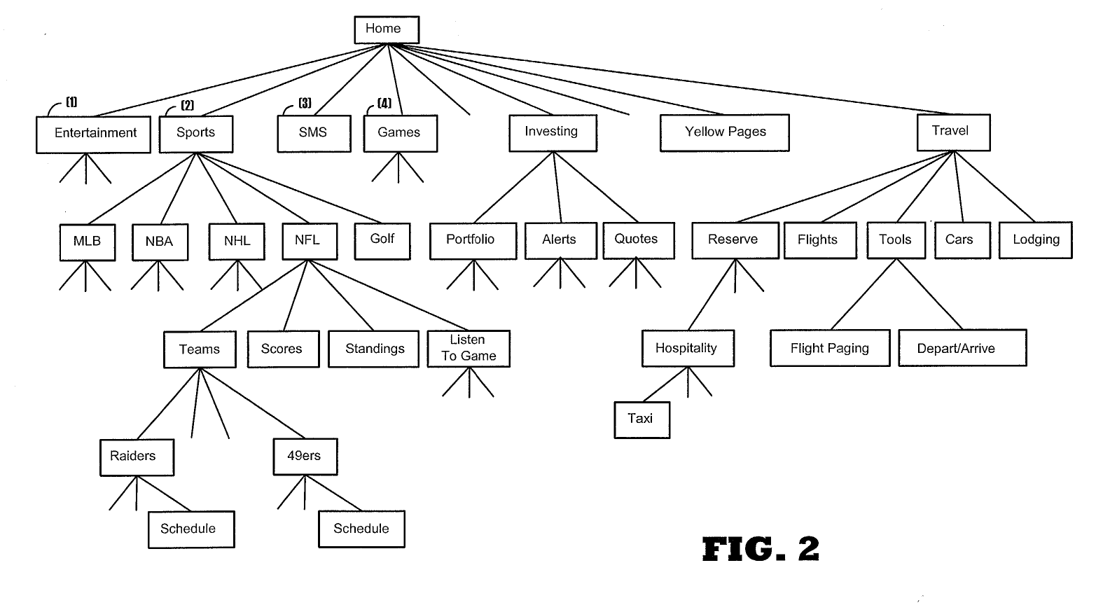

A collection of alternative choices may be pictured as arranged in a hierarchical organizational structure, in which categories of choices branch into various levels of subcategories which eventually split up into the end alternatives, which are the applications available to the user. A typical hierarchical structure used for illustration here is the tree, an example of which is shown in FIG. 2. Categories of choices such as Entertainment, Sports, or SMS (Short Message Service) branch out into further subcategories, which may branch out into yet more subcategories until individual branches finally terminate in the illustrated end alternatives. For simplicity and clarity of exposition, the alternative choices available to a user are described herein as organized in trees. The invention, however, applies to any other hierarchical organizational structures as well, and those skilled in the art, given the benefit of the tree structures illustrated herein, will readily be able to apply the techniques disclosed herein to other hierarchical organizational structures. For example, the techniques disclosed here may be applied to any organizational structure that is made up of a plurality of ordered lists, whether the lists are arranged as a tree or more complicated structure. The techniques can also be applied to looping structures. If one considers the organizational structure of choices to be a form of graph, a tree is commonly understood to be the specific case of a graph that has no cycles, that is to say, has no loops that can be traced by following some path through the graph. In fact, the arrangements of alternative choices transformed by the invention in many real situations are more likely to have cycles than not. For descriptive simplicity and visual clarity, however, all examples are presented here as trees.

The net result of applying the optimization engine to an input hierarchical structure of alternative choices is to produce an output hierarchical structure of alternative choices in a recommended order of greater or more immediate utility to the user. The applications are positioned in the recommended structure according to their intended probability of selection as determined by the optimization engine. This positioning does not necessarily follow solely according to the user's probability of selection based upon a user's past usage because the scenario manager may adjust the probabilities, for example, to take into account other, non-user factors such as commercial biases expressed by the service operators and application providers. Commercial biases incorporated into the optimization engine may improve the positioning of an application in the tree beyond that based solely on the user's past selection history, and this capability allows the operator or application provider to engage in commercial advertising, promotions, and other commercially valuable activities that benefit from such improved positioning. Improving the position of a choice in the hierarchical structure raises the probability that the user will select the choice because users are more likely to select applications requiring fewer keystrokes or applications that are positioned in more prominent locations on a 2-D display screen. The recommended ordering thus corresponds to a ranking according to the calculated probability of the user's selection where commercial intentions of the service operator or of others and other non-user externalities, as well as the user's past selections, statistics or expressed preferences influence that probability.

In operation, the initial, generic tree is provided to the scenario manager by platform 12 and encompasses the alternatives offered by the service operator to the user. The generic tree is generally totally lacking in personalization for any one user, although as will become apparent below the adaptive methodology of the invention may still be used to advantage even if the initial tree should include some elements of personalization. FIG. 2 shows an example of a generic tree modeled after the home page of the Excite Internet portal. The totality of choices available through the Excite home page is quite large and is organized as a complex graph structure. For purposes of illustration, only a few elements are shown here and these are represented as a tree. For example, the lists of alternatives appearing in just the “Explore Excite” block of the home page has 63 items. With only four display lines on the cell phone, sixteen scrolling keystrokes would be required to view all 63 alternatives. An abbreviated list first displayed to the cell phone user might contain for example only the items: “Entertainment,” “Sports,” “SMS,” “Games,” “Investing,” “Yellow Pages,” and “Travel,” in that order. (See FIG. 2.) The top to bottom ordering of the cell phone display is represented as left to right in the Figures showing a tree (FIGS. 2, 4, 5). The numbering in parentheses in FIG. 2 shows the first four items on the display 21 of cell phone 10 in FIG. 3, where the designation (1) indicates the top item and (4) indicates the bottom item. The items of the first row of FIG. 2 represent a list, and each item when clicked will show another list represented as the next level in the tree. For example, clicking on “Travel” will produce the list: “Reserve,” “Flights,” “Tools,” “Cars,” and “Lodging.” Subsequently clicking on “Tools” will produce “Flight Paging” and “Depart/Arrive.” Subsequently clicking on any one of those will produce the list corresponding to that item, and so on to whatever depth is appropriate for that particular path through the tree. The application appears as the end alternative in the path through the tree. When an application is reached, it assumes control and provides its own displays, displacing the lists or other display provided by the scenario manager.

### Distance to the End Alternative

Before proceeding to the details of the optimization method, it is beneficial to formalize the notion of ordering to provide a quantitative measure of the “position,” that is, the priority or relative weight given to the various alternative choices in an organizational structure such as a tree. First, a specific example is given with reference to the limited display capability of the typical cell phone as illustrated in FIG. 3. The cell phone display 21 shows five lines of display, four of which are available to show four alternative choices, that is, four nodes of the tree, to the user at a time, and the fifth of which is reserved for scrolling to the next four nodes. In general, the invention is particularly useful with electronic devices such as the cell phone illustrated here that have a display capable of showing only a small characteristic number of alternative choices to the user at a time. For extremely small devices such as a wristwatch-based computer the characteristic number of alternatives may only be one or two, while the characteristic number may be larger for intelligent instrument control panels of the type that make a number of control and maintenance functions available to a user. In the cell phone example of FIG. 3 only the first four items on any list can appear on the display. In this example, the first four at the top level are “Entertainment,” “Sports,” “SMS,” and “Games”; the last line displaying “Other” is for scrolling to the next four entries on the same level. The cell phone includes a means for indicating which item on the list the user is pointing to. In FIG. 3 the pointer appears as a highlighting of the Sports category. Should the user select the item pointed to, the next list that will appear is seen from FIG. 2 to be: MLB, NBA, NHL, and NFL in that order. To select NFL, the user must click the pointer down to NBA, then to NHL, then to NFL, and then click select, for a total of four clicks. The number of clicks needed to select a given end alternative, that is, to select a leaf at the end of a path through the tree, or to select any intermediate list is taken here as a measure of the distance to the end alternative or intermediate list. The distance is sometimes referred to more figuratively as the click length of the given end alternative or list.

In other settings the distance to an alternative choice may be thought of more generally as the number of navigational steps to be undertaken to step through the hierarchical organizational structure to reach the alternative. In a cell phone capable of displaying only a few lines of a list, this amounts to the number of clicks exercised as the user progresses through the tree along neighboring nodes from left to right and from top to bottom along a path terminating in the desired end alternative. The cell phone is an example of a 1-D display, where selecting any one node of a set of nodes at the same level requires a user manipulation, a “click,” for each node encountered while progressing along the 1-D display to the desired destination node. In devices with 2-D graphical display screens, the navigational path may not be limited to neighboring nodes since the user may be able to activate an icon or hot spot at any position on the graphical display screen by simply positioning a movable cursor on it and clicking without necessarily scrolling through a list. In that case the selection of any node at the same level costs nothing in clicks. The distance between two such nodes in navigational steps is zero in the 2-D case and some number greater than zero, namely, one click for each successive position separating them, in the 1-D case.

In graph structures involving loops the path to a given end alternative may not be unique. In such cases the distance may be taken as the shortest such navigational path terminating in the end alternative, regardless of the particular sequence of user manipulations that may actually be undertaken to get there. In particular, if two independent sequences arrive at different destinations with the same number of total user manipulations, the distances are considered equal and can both be equally minimal if no distances are shorter. Note that the distance depends on the structure of the tree (or more generally on the graph structure) as well as on the nature of the display, that is, the characteristic number of alternatives that can be simultaneously displayed in a list display or the number of icons or other hot spots that can conveniently be displayed on a graphical display screen. The distance of the i-th alternative choice is generally indicated herein by the symbol dᵢ.

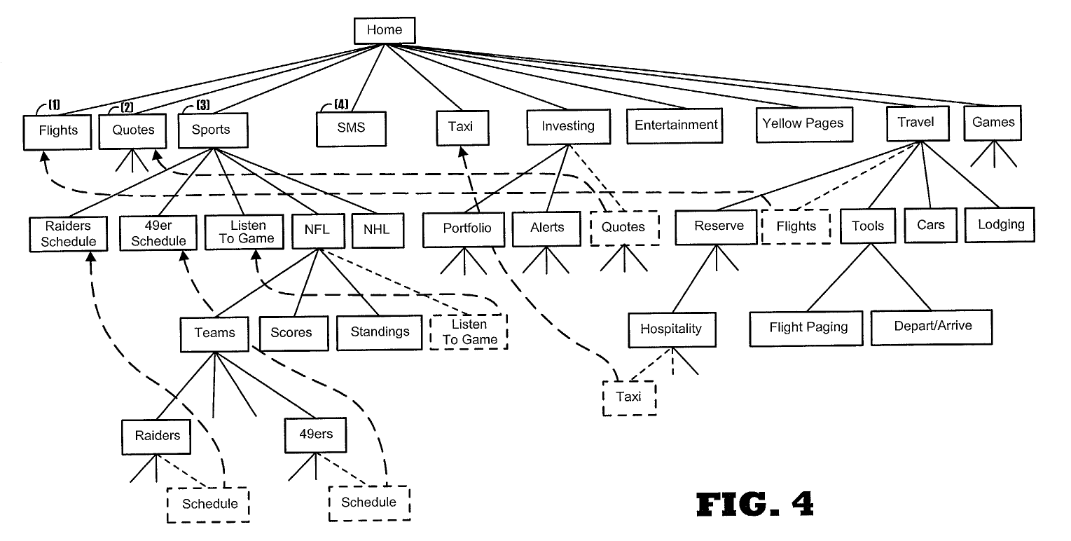

Before proceeding, a few comments are in order concerning the measure of distance. Any hierarchical organizational structure will have a linear ordering associated with it. The tree structure of FIG. 2, for example, may be ordered by numbering the alternative choices from left to right proceeding row by row from the top. The first four choices in FIG. 2 are shown numbered (1) through (4). The assignment of an ordinal position to each alternative choice does not, of course, require a hard-copy printout as shown in FIG. 2, which is offered here only by way of example, but could be made on the basis of any indexing within the data structure. Such an assignment of order does not utilize the notion of navigational steps and is independent of any particular form of display (1-D or 2-D) that may be used to display the alternative choices. Any form of display may then be mapped into the linear ordering of the hierarchical structure. In the example of a cell phone with only a four-item list, the cell phone display may be pictured as a moving window overlaid on the tree of FIG. 2 or 4 and revealing four alternatives in order. Each navigational click either moves to one of the choices displayed in the window or moves the window to reveal four more choices listed in order. In the above example of a 2-D display, a plurality of icons or hot spots representing a plurality of nodes of the organizational tree will generally be displayed simultaneously to the user. An ordering may be imposed on the display screen area such that, for example, icons or hot spots appearing at the top of the screen rank higher than those appearing lower, and for icons or hot spots appearing at the same vertical level those appearing to the left have greater rank than those appearing to the right. Such an ordering may be implemented, for example, by an ordering imposed on the screen coordinates traversed in bands from left to right and top to bottom, or alternatively by dividing the screen area into display cells and assigning an ordinal number to the cells. By such definitions a linear ordering may be imposed even on 2-D displays of alternative choices. The display screen with its ordering may be mapped into the linear ordering of the hierarchical structure of alternative choices. Here the measure dᵢ may be thought of as a combination of click length to bring the alternative to the screen and screen position or cell order to position the alternative at a more prominent or less prominent location on the screen.

As discussed in more detail below, the optimization procedure of the invention optimizes the ordering of the hierarchical structure, promoting some choices to a higher level in a tree and reordering choices that appear on the same level. Once the optimized ordering is determined, the choices are then available for presentation in their recommended order to users over their cell phones or other devices having a variety of forms of display.

The measure of distance in terms of navigational steps, or click lengths, is used in the exposition below of the cell phone example. This measure is advantageous in that it is particularly simple in concept and comparatively easy to apply. Nevertheless, those skilled in the art given the benefit of this disclosure may devise other measures adapted for special situations or for other environments. Thus, in its broad aspect the invention is not intended to be limited to any specific measure or assignment of order illustrated herein.

### Reordering and Promoting

The probability of the user selecting any particular item in the structure is determined by several functions of several independent parameters, variables, and statistics. For example, the user may make different choices in the evening than in the morning, or at home than at work, or in one's home location than when traveling. The choice may be influenced by parameters unknown to the user, for example, parameters which predispose the user's choice to the business advantage of the service operator or application provider. In general, the invention strikes a balance between user benefits and commercial benefits through the functions and statistics based upon a variety of these variables or parameters. This balance is reflected in the structure of the recommended tree of alternatives.

The scenario manager begins the recommendation process by accessing the initial, generic tree from the platform. In some settings the scenario manager may first subject the generic tree to segmenting, grouping or business-rule transformations, as described herein below, preliminary to the optimization process. The result of such pre-optimization transformations is a reduced generic tree that may be adapted for a particular class of users or to a particular class of scenarios although the reduced generic tree will generally still lack any significant customization to a given individual user. The optimization engine then provides the recommended tree in effect by applying an optimizing transformation to the reduced generic tree (or directly to the initial generic tree if no pre-optimization transformations are applied). The optimizing transformation itself generally involves evaluating several functions and is described herein below. First, the effects of the pre-optimization and optimization transformations are briefly discussed.

In general, these transformations are a combination of two types: reordering and promoting.

A reordering transformation reorders the items in a list to place the intended most probable items at the commensurately shortest distance from the beginning of the list. In FIG. 2 the categories at the first level, branching directly from the “Home” location, form a list, and the immediate branches from any of the subcategories form a list. A reordering transformation shuffles the order in which some or all of these entries appear in their respective lists. A promoting transformation promotes items to a higher level in the tree. An example appears in FIG. 4, in which the tree of FIG. 2 has been subjected to promotion and reordering transformations according to the intended probability of selection by the user. The probability is determined by the commercial biases of the operator and application provider as well as the particular user's personal subjective probability of selecting the end alternative. Comparison of FIG. 4 to FIG. 2 shows that the first item, “Flights,” was promoted from the “Travel” list, “Quotes” was promoted from the “Investing” list, and the three items “Sports,” “SMS,” and “Investing” were reordered ahead of “+Entertainment” at the first level. The “Taxi,” “Raiders Schedule,” and “49er Schedule” applications were each promoted three levels rather than one. All were reordered with respect to each other and ahead of several other preexisting entries. The optimization engine provides the recommended tree to the platform on demand for the next list to display. The platform then maintains the recommended tree of choices for presentation to the user at least substantially in the optimized order.

When an alternative is promoted, it is placed in the list above it at a higher-order position than the current list. It will also generally be removed from its current list when it is promoted, although in some embodiments it may be desirable to leave a copy of the promoted alternative in its previous position perhaps grayed out if it is desired to keep track of alternatives' previous positions. For example, in FIG. 4 the “Listen to Game” application was promoted to the same level as “NFL,” but to an ordering just before “NFL,” and it was removed from the list “NFL.” An application can undergo several promotions in the course of any one optimization.

### Optimizing the Objective Function

The optimization engine arrives at the recommended tree by optimizing a particular function referred to herein as the “Objective Function.” This function depends on the relative weights given to the alternative choices in an organizational structure, that is, on their ordering, and includes a number of parameters that reflect preferences and practices of the user and influences external to the user such as preferences of the service operator, application providers or other third parties.

This function operates on an input organizational structure having an input ordering of alternative user choices and as a result of the optimization procedure provides a recommended output organizational structure having a recommended ordering of the alternative choices. The Objective Function includes in its definition a number of parameters that may reflect characteristics of the user, of the applications or application providers, of the operator, or of other third parties such as third-party advertisers. The Objective Function may also generally include one or more parameters that may be referred to as scaling parameters and that are available to be adjusted, typically empirically, to fine tune the results. The specific mathematical form of the Objective Function and the specific parameters, parameter values, and variables on which it depends represent a balancing of many weighting factors to determine an optimized structure for the recommended tree. Various factors already suggested above that may be taken into account by any given Objective Function may include the user's express preferences, the user's personal data such as age, gender, residence locality, occupation, and usage frequencies by the user, by similarly situated users, by the public in general, or by a special segment of the public. It is an advantage of the present invention that the modeling approach espoused here also enables various other types of generally subjective factors to be readily taken into account such as the biases of the operator or third-party advertisers as to what the user wants to see or what the operator subjectively feels or objectively calculates will bring the highest revenues to the operator. That is, through the Objective Function the recommended outcome may be weighted by a wide variety of user-specific and non-user-specific data embodying objective and subjective preferences of users and others. The choice of Objective Function together with the choices for the various parameters and methodologies for setting the parameter values entering into the Objective Function is referred to in the present example as a “business objective model” because it enables the business objectives and preferences of the service operators, application providers and others to be taken into account. More generally, in other contexts the Objective Function and the objectives and preferences realized in the choice of parameters may relate to non-business goals, and the Objective Function and associated parameter choices and methodologies may be referred to more broadly simply as an objective model. The Objective Function is optimized by finding values of the relevant variables that produce a maximum of the Objective Function (or minimum depending on the particular Objective Function).

A description is now given of a business objective model and its use. The Objective Function in this example is taken to be:

Σ(vᵢ+λ)bᵢ e^{-γ di} Expression 1

where the sum runs over the alternative choices, labeled by the index i, available to the user. In this expression bᵢ is a parameter referred to herein as the user's propensity to select the i-th alternative. It is an estimate of the probable frequency with which the given user would select the i-th alternative were the generic tree to be flat. That is to say, bᵢ represents the intrinsic propensity of the user to select the i-th alternative as if the tree had presented all applications at exactly the same distance so that distance had no influence over the user's choice. Loosely speaking, bᵢ may be thought of as a measure of the intrinsic weight which a given user would give the i-th alternative in the idealized situation with “all other things being equal.” The propensity bᵢ is the parameter through which the Objective function takes into account the user's personal objective and subjective preferences for the i-th alternative.

Another parameter entering into the Objective Function is vᵢ. It is a weighting factor that may represent the objective or subjective commercial preferences and bias of the service operator, application provider or third-party advertiser with respect to the i-th application. The value of vᵢ is generally set by the service operator and may be taken for example as a measure of the perceived dollar value of a user selecting the i-th application, although other principles could also be used to set the value of vᵢ. The perceived dollar value, or the measure in general, may be entirely subjective or may be based on the outcome of an objective financial model or other model. In the case where vᵢ is zero, the value of the i-th application may not truly be zero because all usages of an operator's service are of some value to that operator. The Lambda parameter λ, which appears in Expression 1, is an offset to vᵢ to express that value and can be set by the service operator to be different for each market segment. In a second interpretation, Lambda represents the relative importance of business value set by the service operator to the usage statistics of the user. A large Lambda negates the effect of vᵢ in Expression 1.

Gamma, the exponential coefficient γ, is a scaling parameter of the particular business objective model. As the behavior of users and the modeling of that behavior become better defined and understood with use, this parameter is permitted to evolve to fine-tune the model. It is an empirically defined parameter for use in adjusting the performance of the model. The variables dᵢ are the distance measures introduced above.

To execute a business objective model, it is necessary to assign values to the user propensities bᵢ and business weight factors vᵢ. A number of methodologies may be used to assign these values, and all such methodologies are intended to be included within the broad reach of the invention. Since the business objective model and the optimization process are generally under the control of the service operator or similar such party serving as system administrator, the business weight factors may generally be assigned directly by the service operator or administrator. As indicated above, the values may be expressly assigned for example based on experience, instinct or educated guesswork, or they may be assigned based on a calculational scheme such as a financial or econometric model. Such models do not themselves form a part of the present invention and therefore need not be described in any detail here.

The user propensities do not lend themselves to direct assignment by the individual user both because individual users would generally perceive it as an inconvenience if not an imposition to have to make such value judgments for a large number of choices and more fundamentally because the propensities are generally highly subjective and not easily expressed even by the user. The propensities reflect the user's intrinsic preferences as if the generic tree of alternatives were flat, i.e., “with all other things being equal,” and that is an idealized situation not realized in practice. Even the order in which the propensities would be presented to a user for valuation would likely affect the user's value assignments. Moreover, user propensities are generally dynamic, depending on the scenario or on the period of the day (daytime, evening or weekend), for example. As a practical matter the propensities must generally be estimated. At one extreme this may be done simply by querying the user for his or her express preferences with respect to a small number of high-level categories of interest and assigning propensity values inferred from the high-level preferences. Even with this minimal level of user customization the optimization procedure can provide a recommended ordering of alternatives showing improvement over the generic ordering, which may easily be updated whenever the user expressly changes his or her preferences or the service provider changes the business weight factors. In a similar static approach the propensity values may be assigned by application of pre-optimization business rules based on such categories as age, gender, occupation, avocation, zip code, perhaps combined with express user preferences in high-level interest categories.

In another aspect of the invention the optimization procedure greatly enhances utility to the user and is able to incorporate the dynamics of the user propensities by estimating the propensities through a statistical model. A description is now given of example approaches.

The optimization engine accesses the generic tree from platform 12 and retrieves any relevant usage statistics of the user or of other usage groups from database 19. In any practical implementation the generic tree and other data may actually be retrieved from a cache memory instead of directly from a stored database. For purposes of the invention no distinction is made between retrieval from memory and retrieval from more fixed storage or retrieval from a monolithic database or from a collection of data distributed over a plurality of locations. The particulars of the hardware implementation are not germane to the invention, and all such implementations and data retrieval methods are understood to be included when references are made to exchange of data with platform 12, database 19, or any other components discussed herein. These statistics are initialized to some initializing values provided by the optimization engine. They are then recalculated by the optimization engine at appropriate times and updated in database 19. The usage statistics of a given individual user are represented by μᵢ, which is the estimated mean number of times that the user selected application i in a given time interval τ. Although a single time interval τ is utilized here for all applications, in fact different time intervals could be used that might be more appropriate for particular applications or that might be correlated with other parameters. The particular value of τ is not significant for purposes of the present example. The invention may in fact use different values of τ to obtain different behaviors of the optimization engine.

Any number of acceptable algorithms might be used to calculate μᵢ. In the following example, which is one of several different possible algorithms to calculate μᵢ, the variable T is the time interval in which the user's previous choices are considered to be most relative. A very simple example of a formulation is to treat T as a “window” in time, where only those τ intervals falling fully within the T time period are valid. The T duration is an aging mechanism based upon the assumption that the more recent selections of a user better represents that user's current preferences than the less recent. For example, the user's interest might shift temporarily because of stock market conditions, periodically because of sports or weather seasons, or permanently because of a change in live style. Several formulations for T are acceptable for use and T may be refined or redefined over time with experience.

This particular example algorithm employs a Poisson distributed variable and can or cannot employ a Bayes estimator of any kind. Neither a Poisson distribution nor an Empirical Bayes estimator are required by this invention, but either or both can be beneficially employed in some uses of this invention. The steps of this example algorithm are as follows, referring to but not giving the detailed algorithm of an Empirical Bayes estimator, that is to say, a Bayes estimator where the standard deviation is not known:

1. Define small time interval τ, and large time interval T=n_{τ}, n an integer. T is used as a rolling “aging” window always having n time intervals τ, but dropping the data of the oldest interval whenever the data of a newest interval is recorded.

2. Define frequency ƒᵢ for each node (category, leaf, or internal application node beyond) as the number of times the given user selects node i during current time interval τ.

3. Execute the ON-LINE loop consisting of the following.

Count selections of each node i for each user during time τ and continuously update ƒᵢ.

Do not retain ƒᵢ=0 as sample points. Samples will be deliberately more sparse.

At end of τ, delete ƒᵢ of first τ of T, for all users, and store the ƒᵢ of the current τ as the (n−1)^{th} interval of T, and start a new τ.

Imagine k nodes i, (generalization language of “application i”) each with a frequency variable ƒᵢ that follows a Poisson distribution in this particular time window T. That makes k Poisson distributed variables, one for each node i, each having no more than n samples, and many having no samples (all ƒᵢ=0).

The set of ƒᵢ will be transformed to the μᵢ off-line, that is to say when the user closes his or her browser. In this way no reordering of the tree occurs during a user's session.

Execute the OFF-LINE loops of the algorithm in a timely fashion.

4. Loop on each user once during each τ. For each user, loop on i and calculate the mean of all ƒᵢ in T. Call it Xᵢ for that node i. Save the Xᵢ for all i for each user. (Skip this step if no Bayesian estimator is to be used.)

Loop on each user. For each user, loop on i and calculate the mean ƒᵢ. If no Bayesian estimator is to be used, set μᵢ for each user to the mean of ƒᵢ for that user. If there are two or more users, and an Empirical Bayes Estimator is calculated for each mean, use any of the well known formulae for Empirical Bayes Estimators, such as the James-Stein estimator or the Efron-Morris estimator. For each user, set each μᵢ equal to the estimator of the mean of the corresponding ƒᵢ.

The calculation of μᵢ may advantageously use one of the Empirical Bayes formulations of estimators. In such cases the calculation takes into account both the mean calculated over the entire population of users or subgroupings of users who subscribe to the services of the given operator as well as the mean for the individual user. The Empirical Bayes estimator can be calculated by several generally known methods. See, for example, An Introduction to Mathematical Statistics and its Applications by Richard J. Larsen and Morris L. Marx, Published by Prentice Hall. See also references cited therein for Empirical Bayes and other estimator techniques. The invention may use several different methods for different situations. One method that may be used in the invention is known as the James-Stein estimator and another as the Efron-Morris estimator. Moreover, it may sometimes be advantageous not to use an Empirical Bayes estimator at all, but rather to use another method not relying on Empirical Bayes statistics; for example, where overall computational speed is of great importance some non-Empirical Bayes method may yield higher throughput. The individual means for each application and each user represent usage statistics that are stored in the database by the optimization engine. The database is generally updated in background mode.

An example of an algorithm to calculate one such Empirical Bayes estimator is given below. The algorithm is executed as part of step 5 in the algorithm given above. It calculates μᵢ as an Empirical Bayes estimator of the mean of the observed frequencies ƒᵢ, of which there are “k” observations in the time period T.

Execute as part of step 5 of the OFF-LINE loop for two or more users. Otherwise, use just the statistics of the statistical model of the user's behavior, setting μᵢ for each user as the mean of ƒᵢ for that user.

5. Loop on all nodes i. For each node i, loop on all n users.

5a. Calculate the sum of all ƒᵢ as:

$$sumU = {\sum }_{i = 0}^{n} {f}_{i} .$$

5b. Calculate the of the squares of all sumU as:

$${sumU}^{2} = {\sum }_{i = 0}^{n} {f}_{i}^{2} .$$

5c. Calculate the statistics of the observed frequencies

The mean is F=sumU/n.

The variance is σ=(sumU²−n F²)/(n−1).

5d. Calculate the shrinkage factor, S, between 0 and 1

If the variance is zero or if the variance is less than the mean, then the shrinkage factor is S=1, otherwise the shrinkage factor is S=mean/variance=F/σ;

5e. Calculate the Empirical Bayes estimator of each mean ƒᵢ as μᵢ where

μᵢ=S*F+(1−S)*ƒᵢ.

Having estimated μᵢ, by whatever the method, the optimization engine then calculates the user's propensity, bᵢ. Although the value of bᵢ cannot be known directly, it can be inferred from the set of μᵢ collected for the user, along with the distance variables stored in the platform database as an attribute of each μᵢ. The inference requires a reconstruction of each past optimization preceding the current optimization. From that reconstruction the bᵢ can be inferred for each user for each of the i-th applications. The general purpose of computing μᵢ is to infer bᵢ.

The values of the variables bᵢ may be initially set for example according to the business rules entered by the service operator. The subsequent values of the variables bᵢ are then calculated from the μᵢ reconstructing the previous trees by successively applying Expression 2, for each i and solving for each bᵢ:

μᵢ=bᵢ e^{-γ di}. Expression 2

The next recommended tree is then constructed by optimizing the Objective Function of Expression 1 for all applications, thereby defining the dᵢ for the i-th application in the recommended tree. Optimization is achieved by calculating the dᵢ so as to maximize Expression 1, assuming that γ<1.

The Objective Function of Expression 1 is an optimizing function chosen for its desirable properties. In particular, it is able to incorporate both user-specific and third-party weighting factors bᵢ and vᵢ. Other functions than that illustrated here may also be used, which may yield different weights that may be more appropriate for example in other environments where the optimization engine may have different objectives from the present example. For example, even if it is not desired to take advantage of the control offered by the third-party weighting factors vᵢ, advantageous optimization can still be obtained with an Objective Function of the form:

Σ(bᵢ+λ)e^{-γ di}

where the user propensities are derived from means μᵢ determined by a statistical model and in particular a statistical model including an Empirical Bayes estimator. Such a model is also referred to herein as an objective model even though the third-party factors vᵢ have in effect all been set equal to 1 so that the business preferences are flat.

### Optimization Iterations

The Objective Function can be optimized in many ways depending upon the function chosen and upon various computational objectives. One technique of the invention is to iteratively recompute Expression 1 for all dᵢ while comparing each value of Expression 1 to the others in order to identify the set {dᵢ} corresponding to the maximum value of Expression 1. The optimization engine begins with the reduced generic tree, setting all dᵢ values accordingly. From those expressions all bᵢ are calculated from the μᵢ according to Expression 2. The Objective Function is then evaluated for each set of values of {dᵢ} as the dᵢ vary from 1 (or 0) generally to a value commensurate with the depth of the tree. The set of values {dᵢ} found to provide the maximum value of the Objective Function is the optimizing set, which establishes the optimized order. For a properly normalized Objective Function, the probability of selecting the i-th alternative is then:

pᵢ=(vᵢ+λ)bᵢ e^{-γ di}. Expression 3

In one preferred embodiment sorting is used to reorder and a “perturbation analysis” technique is used to promote, where variations in the function being optimized are analyzed for single level promotions of the elements of highest probability in each list. The Reordering of each list is done by simply sorting entries so that the elements of highest probability are highest on the list. The value of the sum of pᵢ is then computed for later comparison against other sums. Then the highest probability alternative of the first list of first topmost list is Promoted to the topmost list and the value of the sum of pᵢ is recalculated. If it is greater than the last calculation, it is retained. Otherwise it is discarded. Then the item is returned to its former position and the next item on the list is promoted to the level above, and placed just before the list to which it belongs in the level above. The value of the sum of pᵢ is recalculated and retained if it is greater than the previously retained calculation, or discarded if not. The calculations continue until all promotions have been tried at all levels to obtain the maximum sum of pᵢ. The tree corresponding to that maximum is then the recommended tree until modified by some other transformation.

### Boost Level

The invention provides a convenient way to temporarily or provisionally enhance or diminish the weight of any particular application. For this purpose a Boost Level parameter Bᵢ is introduced into Expression 3, and similarly into Expression 1, as follows:

pᵢ=Bᵢ(vᵢ+λ)b_{i e}^{-γ di} Expression 4

The Boost parameter Bᵢ will typically be set by the service operator to temporarily increase or decrease the business value of the i-th application. This provides a convenient way for example to commercially promote a new application for a short period of time or to temporarily withdraw an application that is temporarily unavailable but is expected to return. A value of Bᵢ greater than 1 will enhance the weight of an application, and a value less than 1 will diminish the weight. The default value of 1 is the neutral Boost level. A value of 0 temporarily removes the application from the recommendation tree. A time interval can be associated with each Bᵢ to cause an automatic return to the default value.

### Multiple μᵢ

More than one estimated mean, μᵢ, may be stored for each application. Several real-time attributes are stored with these usage statistics, some of which are used to distinguish between different values of μᵢ for the same i-th application. For example, the selection of a particular application by a particular user may differ with the time of day, geographic location, and other parameters that change in real time. For instance, consider a user who is a businessperson based in Sausalito, Calif. and who uses an application that organizes business addresses. When that user is in a geographic location distant from Sausalito, say in Los Angeles, the user may be more likely to need the address application during the business day and less likely to need it in the evening hours, and even less likely to need it when at the home base in Sausalito. The value of μᵢ for the address application can then be adjusted according to the user's location and time of day to reflect that the user might select that application with high probability in the morning in Los Angeles, but with lower probability in the evening in Los Angeles, and hardly at all in Sausalito, be it morning or evening.

More stable data that does not normally change often may also affect the user's selection probability. A collection of personal information on each user, generally referred to as the user's profile, is maintained by the platform and is accessible to the optimization engine. The profile may contain a large data set for each user, which may include the user's address, place of employment, gender, personal features, personal preferences, and several other facts pertaining to that particular user. The user's personal preferences are options that the user is able to choose explicitly through menus provided by the platform. The context processor 18 can filter the reduced tree by applying rules inferred from the profile. For example, the optimization engine will automatically elevate the probabilities of Italian restaurants for a user who has declared a personal preference for them.

### Adaptivity

One parameter belonging to the profile controls the “adaptivity”, meaning level of adaptability, by causing the Optimizer to be more or less sensitive to optimization. The optimization can be desensitized in several ways, each with a different interpretation of sensitivity and each with a different effect on the transformation of trees. Each form of adaptivity is named with a different postscript such as Adaptivity-1 or Adaptivity-2. The adaptivity level parameters can be set by the user or by the operator. Two preferred methods are disclosed here although they can be replaced or complemented by others.

Adaptivity-1: The adaptivity level parameter determines how many lines of the displayed list are allocated to optimization. The count begins at the bottom of the screen. For example, if the adaptivity level is set to the value 1, the bottom most line on the screen will display the recommended entry. If the screen displays only 5 lines, and the parameter is equal to 5 or greater, then the entire screen will be dedicated to recommendations.

Adaptivity-2: At the end of the optimizing iterations, the new maximum must exceed the previous maximum by the percentage represented by the adaptivity level parameter. Below that percentage, the current tree structure prevails, even though optimization has identified a new tree structure corresponding to a sum of pᵢ having a greater maximum value. For example, if the current μᵢ is 40% greater than the previously calculated μᵢ, and the adaptivity level is 50%, the previous value will be retained during optimization.

### Anchor

The optimization engine further reduces keystrokes to make selections by providing an exploratory mode in which the user can pause at any element, mark it with an anchor, and then begin a search of some other branches of the tree. The user is free to navigate the other branches in the normal way, perhaps selecting an end alternative. However, the anchored alternative is displayed at the top of the list that appears when the user clicks on “home,” so that the user can immediately return to the anchor as if the exploratory search had never taken place. The anchor reduces keystrokes by allowing the user to shortcut to the anchor alternative rather than to enter all of the keystrokes necessary to navigate to that anchor point. A keystroke is provided by which the user can remove the anchor and therefore terminate the display of the alternative at the top of the home list. Any number of alternatives can be marked with anchors, in which case they will appear in sequence on the home page, in the order in which they were marked.

### The Reduced Generic Tree

Before estimating the means μᵢ, context processor 18 may transform the generic tree into the reduced generic tree according to the group and segment of the user. Both are abstract terms that can be given meaning by the operator and the application provider through business rules. For example, a user may belong to the group of men over 21 years of age and, at the same time, belong to a group of house owners. Independently, the same user may belong to the western segment, meaning that he lives in one of the states considered to be western. The difference between groups and segments is mostly in usage, with groups generally being more narrowly defined than segments. Another set of business rules may then operates on the groups and segments. The generic tree can be filtered to produce only those end alternatives marked for the groups and/or segments to which the user belongs. For example, a business rule declared by an application provider might state that the application is only to appear to users, “If in Group 1 or Group 3 and not in Group 7.” A change in group or segment need not be made in real-time, as soon as the change takes place, but may wait for a general periodic update in which other parameters are also updated at the same time.

By contrast, the generic tree can be reduced by real-time content filters which effect the user's expressed constraints in real-time. For example, the subscriber may wish to see restaurants within a five-mile radius of their current location. This location will not be known except in real time. Real-time content filtering takes the form of Boolean expressions defined on attributes of the alternatives listed in the content. Although the filters are invoked in real time, they must be registered by the application with the scenario manager before they can be used. Each filter will typically contain parameters whose values will be specified at the time of invocation. The following basic operators are supported:

AND, OR, NOT, GT (for >), GTE (for >=), LT (for <), LTE (for <=), EQ (for =).

The result of applying a real-time content filter to a generic tree is to eliminate substructures that are excluded by the filter constraints.

### Advertisement and Promotion

The invention provides commercial slots, places in the navigable structure where commercial messages can be situated. Through the use of slots, the application providers are able to introduce advertising and promotional messages to the user in the normal navigation of the reduced tree. Advertising appears as unusual selections, located as declared by the application provider. The selection may not cause navigation to occur if only the presentation has value to the advertiser. A slot can be related to some other list or application by a business rule provided by the advertiser. The advertising Slot appears only as long as the optimization engine is instructed in real time, by platform 12, to repeat for the next user. For example, the platform may count the number of times the advertisement appears, and price the service accordingly. By contrast, the promotional slot is an elevation of an existing application to a higher structural level of smaller distance. Promotions generally remain in place until withdrawn by the platform.

### Context Correlation

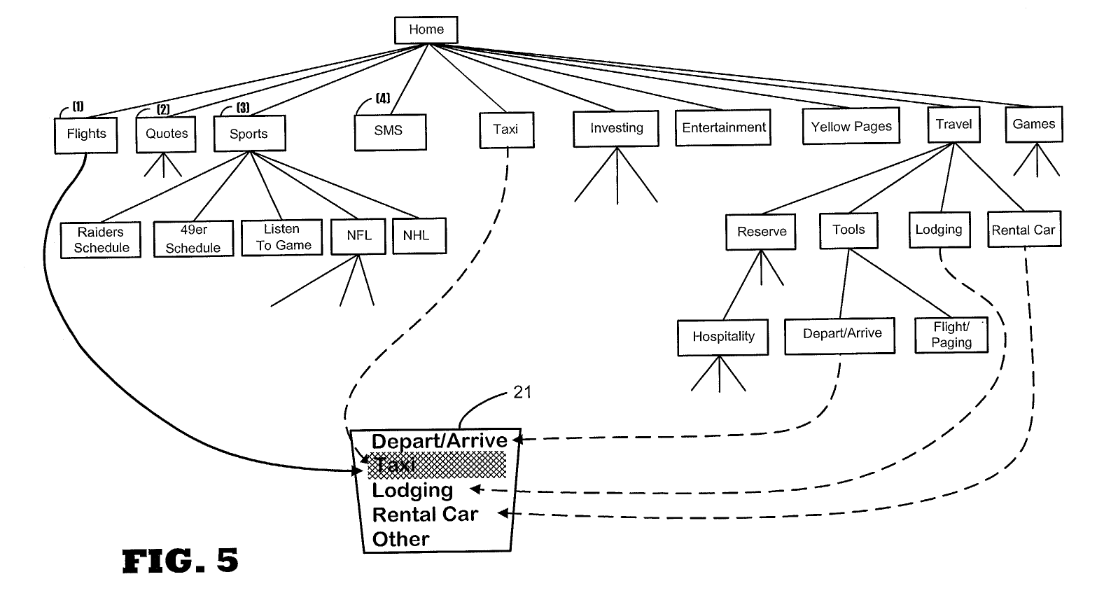

Context processor 18 assembles a correlation list based upon the current selection, the history of selections leading to the current selection, and a correlation matrix which contains the correlation between the lists. The platform then displays the list as a recommended starting point for the next selection sequence after the user has signaled the completion of the current selection sequence by selecting an application. The correlation between two applications is represented as a probability that the user will select the second application after having selected the first. For example, a businessperson might have a high probability of reserving a rental car after having reserved an airline flight. FIG. 5 illustrates the assembly of a correlation list from a recommendation tree. The four entries in the list correspond to the four most likely correlated lists after the user has selected an application from the flights list. The probabilities of the four items use the same Bayes Estimation formulation and Objective Function as do the μᵢ. However, other approaches may be used, including other Objective Functions and estimators that are not Bayesian.

The probability of each list to be recommended for a correlation list is estimated as a sum of the conditional probabilities of all lists in the sequence of lists that might be selected in the process of selecting the application. Expression 5 shows an example for the probability of “taxi” appearing in the correlated list:

P(taxi/“all paths”)=P(tax/flight)+αP(taxi/travel)+α2P(taxi/reserve)+ . . . , Expression 5

where P(i/j) is the conditional probability that the i-th list will be selected if the j^{th} list has been previously selected. The meaning of the abbreviation “all paths” is the sum of all paths to arrive at the “taxi” list. Several totally independent or partially collinear paths are possible because the easily pictured “tree” is not usually a tree structure at all, but rather a graph of multiply connected nodes, which is more difficult to picture. The coefficient α is a parameter of the model chosen to raise the computed conditional probability by past selections, but rapidly diminish the effect with the number of clicks separating the past selection from the recommended list. Expression 5 is a preferred example on the basis of some of its mathematical properties. However, these probabilities may not be computed on the basis of Expression 5, but on some other formulation having different properties, should some other formulation be considered preferable.

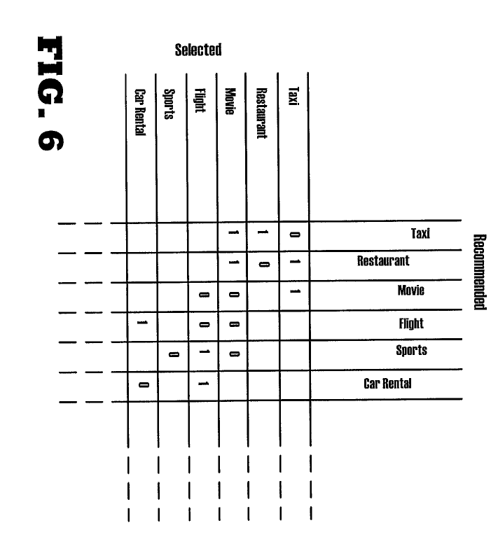

The P(i/j) are represented by the correlation matrix, a Markov matrix of conditional probabilities which the context processor updates in real time whenever the P(i/j) are recalculated. One preferred method to calculate the conditional probabilities is to use the same optimizing function as is used to calculate the μᵢ. The correlation matrix is initialized from the initializing correlation matrix illustrated in FIG. 6. The logical user's interface, or LUI, according to the invention provides a user-friendly graphic interface with which the application provider can enter parameters and rules that declare commercial intentions and biases. Initializing parameters are among those that may be entered. To initialize the correlation matrix, the application provider marks a matrix cell with “0” if there is never to be a correlation, and with “1” if a correlation is initially forced between the two paths. For example, if the user is never expected to reserve an airline flight after just searching for a movie to see, then the matrix element (Movie, Flight) is set to “0” by an application provider. Conversely, if the user is expected to order a taxi after making reservations at a restaurant, then the matrix element (Restaurant, Taxi) is set to “1” by an application provider. A matrix element with neither value is interpreted as a “don't care” value, meaning that the correlation between the two lists is established by the conditional probabilities of the context processor. The value begins as zero but, in contrast to the elements marked “0,” the value can be changed by the context processor.

### Intelligent Data Sharing

To further reduce the keystrokes, clicks or spoken words, required of the user, the invention provides for sharing data between applications to reduce the number of times that the user must enter a lengthy sequence of keystrokes. When lengthy data, such as a mailing address, is requested of the user by the currently selected application, and that same data had been entered previously to some other application, the invention offers the user a list of recommended prefill data objects that might contain the previously entered data. The user can fill in a field of the requesting application by selecting the required data item from the recommended prefill list rather than entering it anew. This form of data sharing is referred to here as implicit application collaboration, or just collaboration, because applications effectively collaborate in satisfying the user's requirements without explicitly causing the collaboration to occur. The object types and other information used in collaboration are obtained from the user by the LUI. Each application provider must provide registration information to become known to the operator. That information contains the specific data needed by the invention to cross-match object types and relevancies.

For the taxicab example introduced above, a user might use a cell phone to reserve a table at a restaurant. The user might then order a taxicab for transportation to that restaurant. The taxicab application will need to know both the pick-up and drop-off addresses, each of which could consist of 40 or more keystrokes. However, both addresses are known by the context processor. The user's own address appears on the prefill list because it is known from the user's profile. The restaurant address appears on the prefill list because of collaboration. It was previously entered as part of the registration process of the restaurant application. The user responds to the taxicab application requests by selecting the user address from the recommended prefill list to fill in the pick-up address, and the restaurant address to fill in the drop-off address. The context processor then provides the data objects to the requesting application as if they had been entered directly by the user.

The context processor can infer that a pick-up address is a data object of the “mailing address” type, regardless of its name, because the type is declared during the registration of every application. Similarly, the user's address is declared as a mailing address in the user's Profile. The use of object types is critical because mailing address data objects can have different names in different applications, for instance “home address,” “residence address,” “customer's address,” “mailing address,” and others. The context processor can recommend all as “mailing addresses” because all were declared as that type by the applications when registering. In addition to matching type, the list can be reduced, by the context processor, according to the constraints of business rules based upon the location of the user, the time, and other factors. The alternatives are displayed as candidate on a list from which the user can select the appropriate object. The complete data represented by the selected alternative can then be provided to the requesting application as if it were entered directly by the user.

A probability, aⱼ is associated with each of the j candidates for data sharing in each of the data object categories. The recommended list of candidates is ordered according to this probability. Where display areas are severely limited, only the first few candidates will appear. Therefore it is important to de-emphasize candidates that have not been selected recently. This “aging” process is expressed in Expression 6.

aⱼ=Dⁿ Expression 6

where D is the decay factor, D<1, and n is the number of other choices, not the j^{th} candidate, that were made since the last selection of the ^{jth} candidate. The value of D is a parameter of the statistical model and may be changed from time to time in order to better fit the model to the desired behavior.

### Idioms

The keystrokes required by an application can be reduced by substituting previously used sequences for a single alternative, just as previously entered data can be referenced as one alternative by intelligent data sharing. The scenario manager provides a reference, referred to as an idiom, that represents a sequence of selections frequently made by a user while using a particular application. Instead of selecting each step in the sequence individually, the user can select the idiom, for which the scenario manager substitutes the specifications representing the sequence. For example, in a banking application, the user might be asked to first select the kind of transaction (for instance “account transfer”), then the account to transfer from (for instance “savings”), and finally the account to transfer to (for instance “checking”). If the user tends to make this sequence of selections regularly, a significant reduction in keystrokes is provided by a single option which specifies “transfer money from savings to checking”. The scenario manager maintains statistics on the applications clickstream and provides the appropriate specifications on request by the Application.

### Object Oriented Architecture

The benefits of Object Oriented Design, or “OOD,” are well known and are well suited for use in implementing the invention. The Java programming language brings those benefits to the invention but also goes beyond to those well known additional benefits of Java. Among them, the interface concept in Java is particularly beneficial for implementing the invention because of the need for reusability and understandability of the products based upon the invention. The invention can be used by software developers who do not modify the products based upon the invention but only interface to them. For that reason, the preferred embodiment of the invention provides API that pass XML blocks, as well as API that are documented Java interfaces.

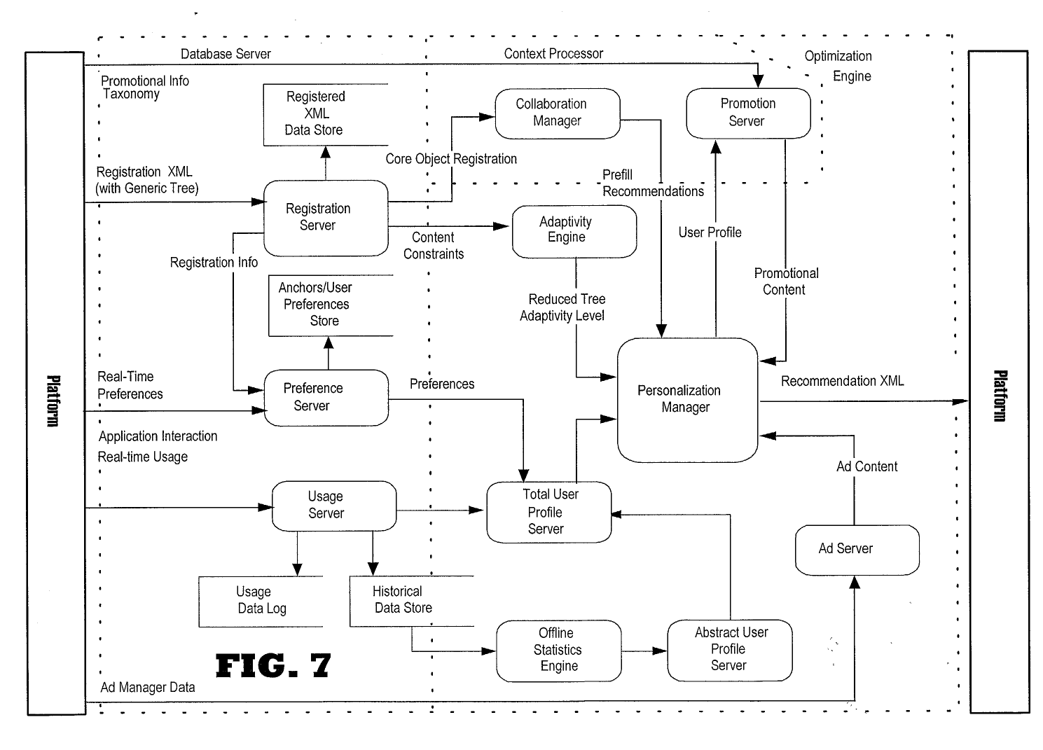

FIG. 7 is a dataflow diagram of a preferred embodiment of the invention. The rectangles of rounded edges are major Java classes. Many more classes exist that are not shown on the diagram because they are used by the classes of the diagram, or because they are occupied with administrative and other tasks that are not germane to the main concepts of the invention. The square rectangles open at the right represent relational database tables or other storage structures. The dashed rectangles at the two ends of the diagram represent the Platform. Data flows from the Platform at the left, through the classes of the invention, and out to the Platform at the right. The groupings of classes in FIG. 1 are enclosed by dashed lines in FIG. 7 and labeled “Database Server,” “Context Processor,” and “Optimization Engine.”

FIG. 7 makes reference to, but does not show, a group of classes referred to as core objects. These classes describe objects which form the basic building blocks of many commonly used mobile applications. For example, the core could include a DateTime class, a Location class, a Telephone class, a Person class, etc. The scenario manager does not have any domain knowledge since application semantics best reside in the application. However, the system does associate limited semantics with core classes where impracticable to ignore. Every core object used by an application must be registered if it is to participate in intelligent data sharing between applications. Registration is the process by which an application simply provides the system a unique id for each core object being used along with its class.

In FIG. 7 some references are made to real-time information. Another descriptive name for real-time information is on-line information, both terms meaning preference information that is pertinent to a particular user and provided by the Platform during the time that the user is being served by the scenario manager. For example, real-time content filters need to have information on the user's preferences of the moment, such as the user's constraint that only restaurants within five miles of the user's current location are of interest. The user's anchor is another example. Real-time information of this kind is passed from the Platform to the Preference Server Class, of FIG. 7, which in turn stores it in the database and passes it, on request, from the database to the Total User Profile Server Class of FIG. 7. The Preference Server Class also provides off-line preference information to the Total User Profile Server Class. The term “off-line” refers to that information that is passed from the Platform whether or not some specific user is on-line. Such information is updated on a periodic basis, for instance daily.

All data from the Platform, except for advertising and promotional information, passes from the database server in the Platform to the database server of the invention. The input referred to as “Registration XML” includes the greater part of the data used by the invention. It includes the generic tree, implemented as an XML block, and all personal data for each individual user, represented as an XML block for each user. The Registration Server Class stores the data of the Registration XML block in a standard relational database such as an Oracle product. The generic tree remains in XML representation.

The complete user's profile is constructed from several sources. Usage information from the Platform is logged and preserved in the Historical Data Store by the Usage Server Class. It includes the clickstream and Core Objects relevant to the selected application. A complete history of each User's activities can be reconstructed from the Historical Data Store. The Offline Statistics Engine references the Historical Data Store to compute the statistics for each User. They are computed off-line, and do not change during the User's active Scenario so that the recommendation tree does not reorganize itself in a confusing way for the User. User statistics can be recomputed on a daily basis. The Abstract User Profile Server Class provides only the information pertinent to the Recommended Tree. The Preference Server Class is able to retrieve Registration information through the Registration Server Class. The Total User Profile Server Class can then assemble the complete user profile by retrieving the user's on-line and off-line preferences and personal Registration information from the Preference Server Class, the application and usage information from the Usage Server Class, and the pertinent statistics from the Abstract User Profile Server Class.

The Personalization Manager Class in FIG. 7 constructs the recommended tree, an XML block, as a final processing of information from other classes within the optimization engine and from the context processor. The user profile is provided by the Total User Profile Server. The reduced tree is provided by the Adaptivity Engine Class which obtains the generic tree and constraints from the Registered XML Data Store through the Registration Server Class. It applies the constraints to the generic tree to obtain the reduced tree. The Collaboration Manager Class executes the intelligent data sharing on the core objects used by applications and produces the prefill recommendations, for the given user, that replace the recommendation tree while the user is interacting on-line with the application.

The two remaining sources of information for the Personalization Manager are concerned with advertising and promotion. They derive data directly from the Platform through API used by the Service Operator or Advertiser. The API of the Promotion Server Class requires the promotional information such as the content and business rules for associating the promotion with specific User selections. From that, the Promotion Server Class provides the Personalization Manager Class with the specifications necessary for accommodating the promotion in the recommended tree. A similar processing of advertising data is provided by the Ad Server Class to the Personalization Manager Class so that it can transform the recommended tree to accommodate the Advertising Slot.

The recommended tree is then produced by the Personalization Manager Class and passed to the Platform as an XML block.

The above descriptions and drawings are given to illustrate and provide examples of various aspects of the invention in specific embodiments. They are not intended to limit the invention only to these examples and illustrations. Given the benefit of the above disclosure, those skilled in the art will generally be able to devise various modifications, alternate constructions and alternate implementations for different types of electronic devices and different situations of use that although differing from the examples disclosed herein nevertheless enjoy the benefits of the invention and fall within the scope of the invention, which is defined by the following claims.

What is claimed is:

1. A method for presenting an optimized selection of alternatives from a plurality of alternative choices to a user through an electronic device, comprising the steps of:
providing an objective model for said plurality of alternative choices, said objective model reflecting at least user-specific weighting factors for said alternative choices;
applying said objective model to a first ordered selection of choices to derive a recommended selection of choices of optimized order, said optimized order being determined by said objective model; and
maintaining said recommended selection of choices for presentation to said user through said electronic device substantially in said optimized order.

2. The method of claim 1 wherein said objective model further reflects third-party weighting factors.

3. The method of claim 2 wherein access to said plurality of alternative choices is provided by a service operator and said method further comprises the step of including in said objective model a weighting factor reflecting preferences of said service operator in presenting alternatives to said user.

4. The method of claim 3 wherein at least one of said alternative choices is provided by a third-party advertiser and said method further comprises the step of including in said objective model a weighting factor reflecting preferences of said third-party advertiser in presenting alternatives to said user.

5. The method of claim 2 wherein said objective model includes an Objective Function of the form:
Σ(vᵢ+λ)bᵢ e^{-γ di}
in which the parameters bᵢ reflect said user-specific weighting factors, the parameters vᵢ reflect said third-party weighting factors, the variables dᵢ represent an ordering of said plurality of alternative choices, and the parameters λ and γ are empirically adjusted constants.

6. The method of claim 5 wherein the summation in the Objective Function runs only over end alternatives.

7. A method for presenting an optimized selection of alternatives from a plurality of alternative choices to a user through an electronic device, comprising:
providing an objective model for said plurality of alternative choices, said objective model including a plurality of user-specific weighting factors;
providing a statistical model for setting the values of at least some of said user-specific weighting factors and applying said statistical model for setting said values;
applying said objective model with said values set by said statistical model to a first ordered selection of choices to derive a recommended selection of choices of optimized order, said optimized order being determined by said objective model; and
maintaining said recommended selection of choices for presentation to said user through said electronic device substantially in said optimized order.

8. The method of claim 7 wherein said statistical model includes an estimator of Empirical Bayes formulation for setting said values.

9. The method of claim 7 wherein said objective model further reflects third-party weighting factors.

10. The method of claim 9 wherein said objective model includes an Objective Function of the form:
Σ(vᵢ+λ)bᵢ e^{-γ di}
in which the parameters bᵢ reflect said user-specific weighting factors, the parameters vᵢ reflect said third-party weighting factors, the variables dᵢ represent an ordering of said plurality of alternative choices, and the parameters λ and γ are empirically adjusted constants.

11. The method of claim 10 wherein said statistical model includes an estimator of Empirical Bayes formulation for determining said parameters bᵢ.

12. A method for presenting an optimized selection of alternatives from a plurality of alternative choices to a user through an electronic device, comprising the steps of:
providing an objective model for said plurality of alternative choices;
applying said objective model to a first ordered selection of choices to derive a recommended selection of choices of optimized order, said optimized order being determined by said objective model;
presenting said recommended selection of choices to said user substantially in said optimized order for further selection of an end alternative by said user;
when said end alternative calls for entry of data by said user, applying said objective model to derive a recommended selection of prefill data objects; and
presenting said recommended selection of prefill data objects to said user.

13. A method for presenting an optimized selection of alternatives from a plurality of alternative choices to a user through an electronic device having a display capable of showing only a characteristic number of choices to the user at a time, comprising the steps of:
providing an objective model for said plurality of alternative choices, said objective model reflecting at least user-specific weighting factors for said alternative choices;
applying said objective model to a first ordered selection of alternative choices to derive a recommended selection of alternative choices of optimized order, said optimized order being determined by said objective model; and
maintaining at least a portion of said recommended selection of alternative choices for presentation to said user a fixed number at a time substantially in said optimized order, said fixed number being at most the characteristic number said device is capable of displaying at a time.

14. The method of claim 13 wherein said objective model further reflects third-party weighting factors.

15. The method of claim 13 further including:
providing a statistical model for setting the values of at least some of said user-specific weighting factors and applying said statistical model for setting said values.

16. The method of claim 15 wherein said statistical model includes an estimator of Empirical Bayes formulation for setting said values.

17. A method for presenting an optimized selection of alternatives from a plurality of alternative choices to a user through an electronic device, said plurality of alternative choices forming an initial ordered data structure, the method comprising:
defining a plurality of characteristic groups of users;
for a given user, transforming said initial ordered data structure into a reduced data structure associated with at least one of said characteristic groups;
applying an objective model to said reduced data structure, said objective model including parameters particularized to said given user, to derive a recommended data structure for said given user.

18. The method of claim 17, further comprising:
applying a content filter to at least one of said initial data structure, said reduced data structure and said recommended data structure, thereby to provide a refined recommended data structure.

19. The method of claim 18, wherein said content filter is applied to one of said initial data structure and said reduced data structure before said objective model is applied.

20. The method of claim 18, wherein said content filter is applied after said objective model is applied.

21. A method for presenting an optimized selection of alternatives from a plurality of alternative choices to a user through an electronic device, said plurality of alternative choices forming an initial ordered data structure, the method comprising:
applying a content filter to said initial ordered data structure to define a reduced data structure; and
applying an objective model to said reduced data structure, said objective model including parameters particularized to a given user, to derive a recommended data structure for said given user.

22. In a system in which a user can access a number of software applications with an electronic device, said device having a display for presenting the user with a number of alternative choices, a method for providing data to a software application in response to a request for data entry by said software application, comprising:
determining a characteristic type of data appropriate for filling said request for data entry;
associating a probability of relevance to a plurality of other instances of data of said characteristic type associated with said user; and
ordering said plurality of other instances substantially in accordance with said probability of relevance for presentation to said user.
